(19) United States
(12) Patent Application Publication
(10) Pub. No.: US 2008/0009223 A1
(43) Pub. Date: Jan. 10, 2008

(54) Interactive Educational Toy

(76) Inventor: Silvana Vairo Gaddi, Como (IT)

Correspondence Address: NIXON & VANDERHYE, PC, 901 NORTH GLEBE ROAD, 11TH FLOOR, ARLINGTON, VA, 22203, US

(21) Appl. No.: 11/663,531

(22) PCT Filed: Sep. 22, 2005
(86) PCT No.: PCT/IB05/53140

§ 371 Date: Jun. 15, 2007

(30) Foreign Application Priority Data
Sep. 22, 2004 (IT) RM2004A000449

(51) Int. Cl. A63H 3/28; G05B 19/00

(52) U.S. Cl. 446/270; 340/5.1; 340/540; 446/304

(57) ABSTRACT

An electronic device for the recognizing and the selecting of a plurality of items belonging to different item groups comprises means for acquiring said items, apt to generate corresponding coded signals identifying the items and the respective groups they belong to; a microprocessor control unit apt to be inputted said coded signals; and one or more output devices activated by said control unit, each of said output devices being apt to provide one or more responses, each response being corresponding to one of said coded signals. Said device could advantageously be utilized for the making of an interactive educational toy, in particular in the field of nutrition education.

The present invention refers to an interactive toy, in particular aiming at nutrition education for children.

It is well-known that children education, especially in childhood, is an extremely delicate issue that needs to be addressed in all seriousness and attention. In fact, it is in childhood that a child learns and assimilates certain behavioural rules, making use of them for the rest of his/her life.

One of the educational aspects which are particularly important, also because it is related to aspects concerning a person's physical health and well-being, is that of nutrition education.

A child should learn as early as possible the rules of correct nutrition, so as to benefit therefrom in the course of his or her lifespan.

Indeed, the main problem encountered in children education, and in particular in nutrition education, is due to the fact that it is impossible to explain to a child the scientific aspects related to the assumption of different foods, the effect that such foods have on our body and therefore the reasons making it necessary to feed oneself according to rigid and preset rules, all concepts apparently out of the child's reach.

On the other hand, it is easy to imagine that no one, all the more a child, could passively accept rigid and preset rules without any incentive to follow them.

Object of the present invention is to solve said problems, by providing an electronic device for the recognizing and the selecting of a plurality of items, each of said items belonging to a predefined item group, comprising:
means for acquiring said items, apt to generate corresponding coded signals identifying the items and the respective groups they belong to;
a microprocessor control unit apt to be inputted said coded signals; and
one or more output devices activated by said control unit, each of said output devices being apt to provide one or more responses, each response being corresponding to one of said coded signals.

Hence, as a further object of the present invention, such a device could be incorporated in an interactive educational toy, particularly aiming at the nutrition education of children, e.g., a doll or the like.

The main advantage of the present invention lies in that, through playing, it enables a child to learn the basic and fundamental rules of correct nutrition, by personally tending to his/her toy.

Further advantages, features and the operation modes of the present invention will be made evident by the following detailed description of a preferred embodiment thereof, given by way of a non-limiting example, making reference to the figures of the annexed drawings, wherein:

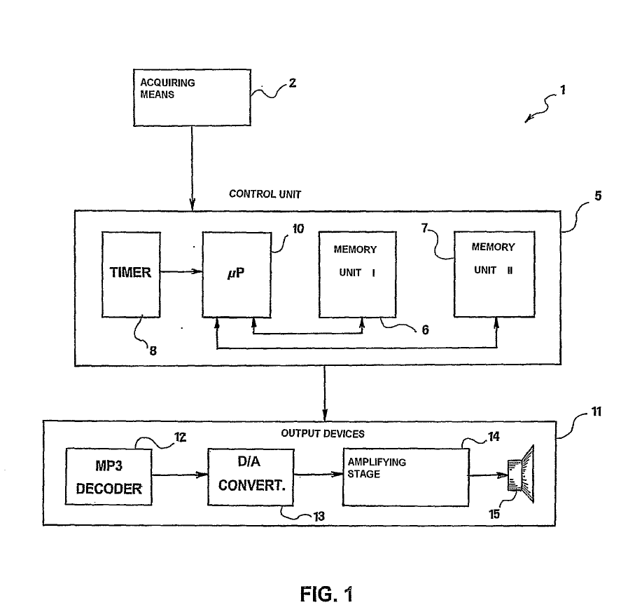

FIG. 1 is a block diagram of a device according to the present invention;

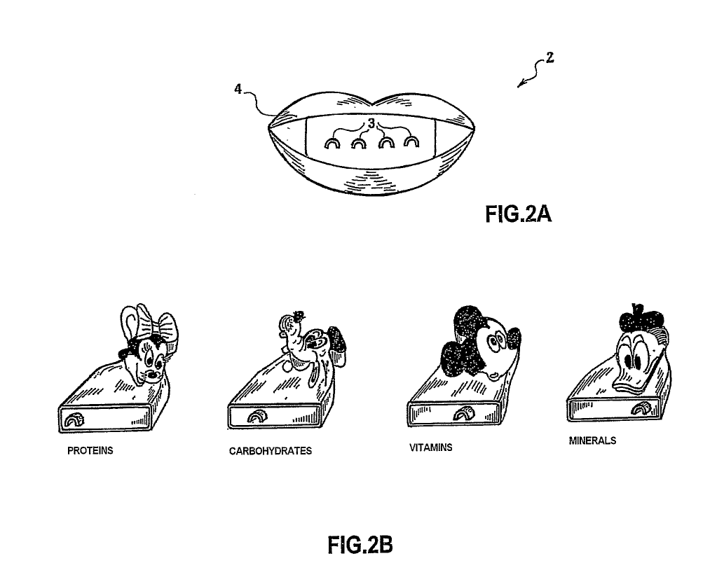

FIG. 2A is a schematization of the acquiring means of FIG. 1;

FIG. 2B illustrates some possible examples of items;

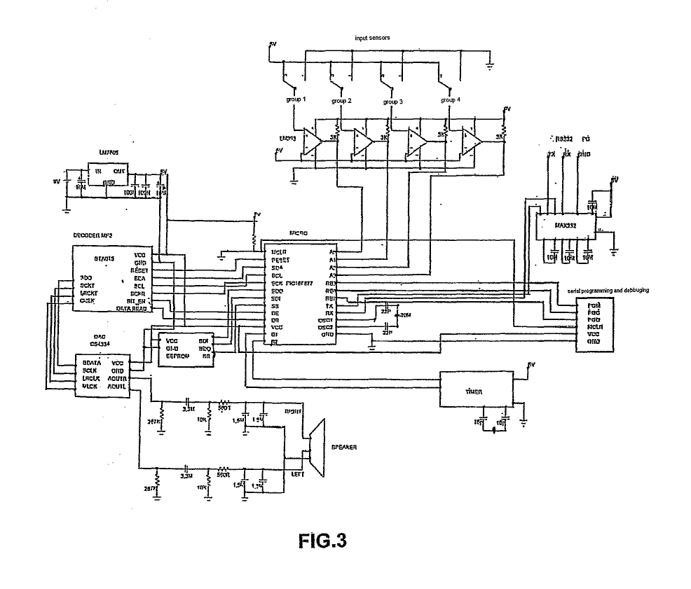

FIG. 3 is a wiring diagram of a device according to the present invention; and

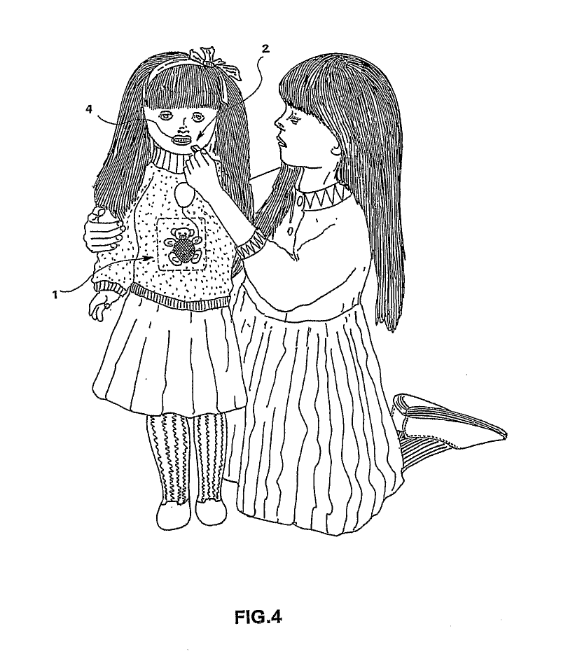

FIG. 4 is an interactive educational toy according to the present invention, in particular a doll.

With reference to the figures, hereinafter it will be described an electronic device for the recognizing and the selecting of a plurality of items.

A device 1, according to a preferred embodiment of the present invention, comprises means 2 for acquiring the items to be recognized.

The items of interest to the ends of the present invention can be arranged in groups.

The acquiring means, exemplified in FIG. 2B, comprises one or more sensors apt to detect the presence of the items when these are inserted from time to time in a predetermined seat 4.

Advantageously, the sensors could be selected according to the typology of the items to be recognized and positioned onto the latter so that, according to their position, the device could be capable of recognizing the corresponding group they belong to.

Hereinafter, reference will be made to items representing different foods, hence belonging to different food groups, such as, e.g., reported in FIG. 2B: proteins, carbohydrates, vitamins and minerals.

It is understood that the foods and the groups could be others, or more, entailing no loss of generality whatsoever, nor variations in the inventive concept underlying the present invention.

Of course, different positioning of the sensors could also provide a selection within a same group, e.g. to single out different foods or different amounts of a same food.

The sensors used could be of different types, e.g. magnetic, mechanical, optical sensors, etc.

The selection, evidently within reach of a person skilled in the art, will depend on the specific hardware implementation and the designing method adopted.

Therefore, said sensors generate various coded signals identifying the different foods provided from time to time and the respective groups they belong to.

Then, said signals are outputted to a control unit 5.

Preferably, the control unit 5 is of the kind having a microprocessor 10 and it comprises a first memory unit 6 apt to contain one or more managing and/or processing programs.

The control unit 5 further comprises a second memory unit 7 apt to contain and store various data, in particular data related to previously sampled words or sentences.

These data, when referred to voice signals, or anyhow to sound signals, are preferably stored in MP3 format.

The device 1 according to the present invention further comprises one or more output devices, activated by said control unit 5, each thereof being apt to provide specific responses depending on the inputs of the device, therefore substantially depending on the coded signals corresponding to a different food.

These responses may be mechanical, by means of the activation of one or more actuators capable of actuating mechanical members, and/or acoustic, through a sound reproduction device 11.

The sound reproduction device 11 comprises e.g. a decoder 12 of data in MP3 format, a digital/analog (D/A) converter 13, an amplifying stage 14 and a transducer 15 for reproduction sounds.

FIG. 3 is an exemplary wiring diagram of a specific embodiment of the electronic device described hereto.

An electronic device according to the present invention may advantageously be incorporated in a toy in order to make the latter interactive and an educational tool for children using it as a toy.

In particular, to the ends of the present invention it will be considered the case in which said toy is an interactive doll that may advantageously contribute to the educational forming of a child with regard to nutrition education.

The game may, e.g., start with a request by the doll, expressing its feeling hungry or reminding the child that it is mealtime (breakfast, lunch, snack or dinner).

At that point the child begins to insert foods, through a specific seat obtained at the doll's mouth.

As described hereto, the sensors are capable of recognizing individual foods, and of transmitting such information to the control unit that processes it.

In particular, it is calculated the energetic value of the provided foods, it is assessed whether the balance among the different groups is correct, and accordingly the control unit activates predetermined procedures enabling the doll to respond interactively.

For instance, there may be selected sentences, stored beforehand, leading the child to correctly feed the doll by providing foods in right amounts and in a balanced manner.

Moreover, according to the energetic value of the provided foods, the doll could perform actions (tell stories, sing or move) for a predetermined time depending on the energetic value itself, and later on request other food if necessary.

Of course, it is understood that these are merely examples of possible operation.

Other modes may be selected, as long as the aim always remains the same: leading the child along an educational path bringing him or her to understand the rules of correct nutrition.

The present invention has hereto been described according to a preferred embodiment thereof, given by way of a non-limiting example.

It is understood that other embodiments could be envisaged, all to be construed as falling within the protective scope thereof, as defined by the annexed claims.

1. An electronic device for the recognizing and the selecting of a plurality of items, each of said items belonging to a predefined item group, comprising:
means for acquiring said items, apt to generate corresponding coded signals identifying the items and the respective groups they belong to;
a microprocessor control unit apt to be inputted said coded signals; and
one or more output devices activated by said control unit, each of said output devices being apt to provide one or more responses, each response being corresponding to one of said coded signals.

2. The device according to claim 1, wherein said means for acquiring said items comprises one or more seats, each of said seats being apt to receive said items.

3. The device according to claim 1, wherein said means for acquiring said items comprises one or more sensors apt to detect the presence of said items.

4. The device according to claim 3, wherein said sensors are apt to generate said signals identifying said items.

5. The device according to claim 1, wherein said microprocessor control unit comprises a first memory unit apt to contain one or more managing and/or processing programs.

6. The device according to claim 1, wherein said microprocessor control unit comprises a second memory unit apt to contain data.

7. The device according to claim 6, wherein said data are related to sampled words or sentences.

8. The device according to claim 7, wherein said data are stored in MP3 format.

9. The device according to claim 1, wherein said one or more output devices comprises an actuator apt to actuate mechanical members.

10. The device according to claim 1, wherein said one or more output devices comprises a sound reproduction device.

11. The device according to claim 10, wherein said sound reproduction device comprises a decoder of data in MP3 format.

12. The device according to claim 10, wherein said sound reproduction device comprises a digital/analog converter.

13. The device according to claim 10, wherein said sound reproduction device comprises an amplifying stage and a transducer for reproducing sounds.

14. An interactive educational toy, characterized in that it comprises an electronic device for the recognizing and the selecting of a plurality of items according to claim 1.

15. The toy according to claim 14, characterized in that it is a doll.

16. The toy according to claim 15, wherein said items represent corresponding foods.

17. The toy according to claim 16, wherein said doll reproduces predefined sentences depending on the foods that are fed thereto.

18. The toy according to claim 16, wherein said doll performs predetermined motions depending on the foods that are fed thereto.
